(19) United States
(12) Patent Application Publication
(10) Pub. No.: US 2016/0154649 A1
(43) Pub. Date: Jun. 2, 2016

(54) SWITCHING METHODS FOR CONTEXT MIGRATION AND SYSTEMS THEREOF

(71) Applicant: MediaTek Inc., Hsin-Chu (TW)

(72) Inventors: Yu-Teng LIN, Zhubei City (TW); Wan-Ching HUANG, Hsinchu City (TW); Yu-Pin LIN, Zhubei City (TW); Nicholas Ching Hui TANG, Zhudong Township (TW)

(21) Appl. No.: 14/799,899

(22) Filed: Jul. 15, 2015

Related U.S. Application Data
(60) Provisional application No. 62/085,793, filed on Dec. 1, 2014.

(51) Int. Cl. G06F 9/30

(52) U.S. Cl. CPC G06F 9/30076; G06F 9/30123

(57) ABSTRACT

A switching method for context migration among a plurality of physical processor cores is provided. Each of the physical processor cores is mapped to a corresponding logical processor core. The switching method includes migrating a processor hardware context from a first physical processor core to a second physical processor core which is different from the first physical processor core. The first physical processor core and the second physical processor core are mapped to a first logical processor core and a second logical processor core which is different from the first logical processor core, respectively prior to the migration. The switching method further includes remapping the first physical processor core to the second logical processor core and remapping the second physical processor core to the first logical processor core.

### CROSS REFERENCE TO RELATED APPLICATIONS

This application claims the benefit of U.S. Provisional Application No. 62/085,793, filed on Dec. 1, 2014, the entirety of which is incorporated by reference herein.

### BACKGROUND OF THE INVENTION

1. Field of the Invention

The present disclosure relates to a switching method for context migration. More particularly, the present disclosure relates to a switching method and a multi-core processor system capable of migrating a processor hardware context and a remapping mechanism corresponding to the migration.

2. Description of the Related Art

Unless otherwise indicated herein, approaches described in this section are not prior art to the claims listed below and are not admitted to be prior art by inclusion in this section.

Multi-core processor system including a plurality of processor cores is widely applied to many electronic devices. Currently, considering the energy efficiency demands of battery powered mobile devices, advances are being made with respect to providing multi-core chips that provide cores of different sizes. As a non-limiting example, big.LITTLE Technology provides both high performance as well as power savings. Among the processor cores, big processor cores belong to a big core having better performance and consuming more energy, while little processor cores have worse performance and consuming less energy. Accordingly, the big processor core could be used to handle the task with heavy loading, and the little core could be used to handle the tasks with light loading.

However, it is difficult to predict or determine the loading of a task, because the loading dynamically changes as the task is running. When the current processor core cannot handle or execute the current task, task migration will need to be performed among the plurality of processor cores. In other words, the current task will be handed over from the current processor core to another suitable processor core. Afterwards, a hot-plug operation will be initiated during the process of the task migration. The hot-plug operation includes transmitting inter-processor interrupt (IPI) information, waking up the suitable processor core, stopping the other processor cores and synchronizing all of the processor cores. However, when other processor cores are stopped during the hot-plug operation, their current tasks will also be postponed correspondingly, resulting in long latency. In addition, the performance of the electronic device also deteriorates. As such, a long latency occurs and the performance degrades due to the hot-plug process of the task migration.

Therefore, a switching method is needed capable of balancing the loading among multiple processor cores, which sacrifices performance to a lesser degree and causes less latency than the above method of task migration.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select, not all, implementations are further described below in the detailed description. Thus, the following summary is not intended to identify essential features of the claimed subject matter, nor is it intended for use in determining the scope of the claimed subject matter.

The disclosure provides a switching method for context migration among a plurality of physical processor cores. Each of the physical processor cores is mapped to a corresponding logical processor core. The switching method includes migrating a processor hardware context from a first physical processor core to a second physical processor core which is different from the first physical processor core. The first physical processor core and the second physical processor core are mapped to a first logical processor core and a second logical processor core which is different from the first logical processor core, respectively prior to the migration. The switching method further includes remapping the first physical processor core to the second logical processor core and remapping the second physical processor core to the first logical processor core.

The disclosure further provides a multi-core processor system, comprising a plurality of physical processor cores and a processor context switcher. Each of the physical processor cores can be mapped to a corresponding logical processor core of a plurality of logical processor cores. The physical processor cores comprising a first physical processor core and a second physical processor core which is different from the first physical processor core, and the logical processor cores comprise a first logical processor core and a second logical processor core which is different from the first logical processor core. The processor context switcher is configured to migrate a processor hardware context from the first physical processor core to the second physical processor core. The first physical processor core and the second physical processor core are mapped to the first logical processor core and the second logical processor core respectively prior to the migration. The processor context switcher remaps the first physical processor core to the second logical processor core and remaps the second physical processor core to the first logical processor core during or after the migration.

The physical processor cores may be Central Processing Units or Graphics Processing Units and any types of processor cores. In addition, the first and second physical processor cores can have identical or different structures/sizes. The processor hardware context can comprise an execution context, an event signal transceiver glue layer, and a debug context.

In a first aspect of the present invention, the switching method can further include disjoining the first physical processor core from a symmetric multiprocessing environment of the plurality of physical processor cores; powering on the second physical processor core in required cases; directly loading contents of the execution context and the debug context of the first physical processor core from the first physical processor core to the second physical processor core without passing through any memory; migrating the event signal transceiver glue layer from the first physical processor core to the second physical processor core; joining the second physical processor core to the symmetric multiprocessing environment of the plurality of physical processor cores; and starting the asynchronous event service. In addition, the switch method may further comprise shutting down the first physical processor core.

In a second aspect of the present invention, the switching method can further include stopping an asynchronous event service; saving the contents of the execution context and the debug context of the first physical processor core from the first physical processor core to a memory; disjoining the first physical processor core from a symmetric multiprocessing environment of the plurality of physical processor cores; powering on the second physical processor core in required cases; reloading the saved contents of the execution context and the debug context of the first physical processor core from the memory to the second physical processor core; migrating the event signal transceiver glue layer from the first physical processor core to the second physical processor core; joining the second physical processor core to the symmetric multiprocessing environment of the plurality of physical processor cores; and starting the asynchronous event service. In addition, the switching method may further comprise shutting down the first physical processor core.

In another aspect of the present invention, each of the physical processor cores can include respective one or more general registers, respective one or more control registers, respective one or more generic timers, and respective one or more floating point co-processor cores. The switching method also includes moving the contents of the one or more general registers, the one or more control registers, the one or more generic timers, and the one or more floating point co-processor cores of the first physical processor core to those of the second physical processor core. The switching method can further includes modifying the contents of the one or more control registers of the first physical processor core to be suitable for execution of the second physical processor core prior to moving the contents of the one or more control registers of the first physical processor core to the one or more control registers of the second physical processor core.

In another aspect of the present invention, the event signal transceiver glue layer can include an interface distributer, and each of the physical processor cores has a respective asynchronous event interface commonly coupled to the interface distributer of the event signal transceiver glue layer, and the switching method further includes reconfiguring the interface distributer of the event signal transceiver glue layer. Furthermore, each of the physical processor cores has one or more respective debug registers commonly coupled to a debugger, and the switching method further includes moving the contents of the one or more debug registers of the first physical processor core to the one or more debug registers of the second physical processor core. In addition, the step of migrating the processor hardware context from the first physical processor core to the second physical processor core can be performed directly or indirectly. The switching method can further include migrating processor hardware contexts between more other processor cores at the same time. For example, the switching method can include migrating another processor hardware context from a third physical processor core to a fourth physical processor core at the same time when the processor hardware context is migrated from the first physical processor core to the second physical processor core.

The switching method and the multi-core processor system according to embodiments of the invention can provide a faster migration, thus addressing requests for performance burst. In addition, the switching method and the multi-core processor system according to the embodiments of the invention cause shorter latency, while simplifying the performance/load balance scheduling algorithms.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1A is a schematic diagram of a multi-core processor system according to an embodiment of the present invention;

FIG. 1B is another schematic diagram of a multi-core processor system according to an embodiment of the present invention;

FIG. 2 is a flowchart illustrating the switching method according to an embodiment of the present invention;

FIG. 3A is a schematic diagram of a multi-core processor system according to an embodiment of the present invention;

FIG. 3B is another schematic diagram of a multi-core processor system according to an embodiment of the present invention;

FIG. 4 is a flowchart illustrating the switching method according to an embodiment of the present invention;

FIG. 5 is another flowchart illustrating the switching method according to an embodiment of the present invention.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF THE INVENTION

The following description is of the best-contemplated method of carrying out the invention. This description is made for the purpose of illustrating the general principles of the invention and should not be taken in a limiting sense. Certain terms and figures are used throughout the description and following claims to refer to particular components. As one skilled in the art will appreciate, manufacturers may refer to a component by different names. This document does not intend to distinguish between components that differ in name but not function. The terms “component”, “system” and “device” used in the present invention could be the entity relating to the computer which is hardware, software, or a combination of hardware and software. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

In addition, it should be noted that the term “multi-core processor system” may mean a multi-core system or a multi-processor system, depending upon the actual design. In other words, the proposed switching method may be employed by any of the multi-core system and the multi-processor system. For example, concerning the multi-core system, all of the processor cores may be disposed in one processor core. For another example, concerning the multi-processor system, each of the processor cores may be disposed in one processor core. Hence, each of the clusters may be implemented as a group of processor cores.

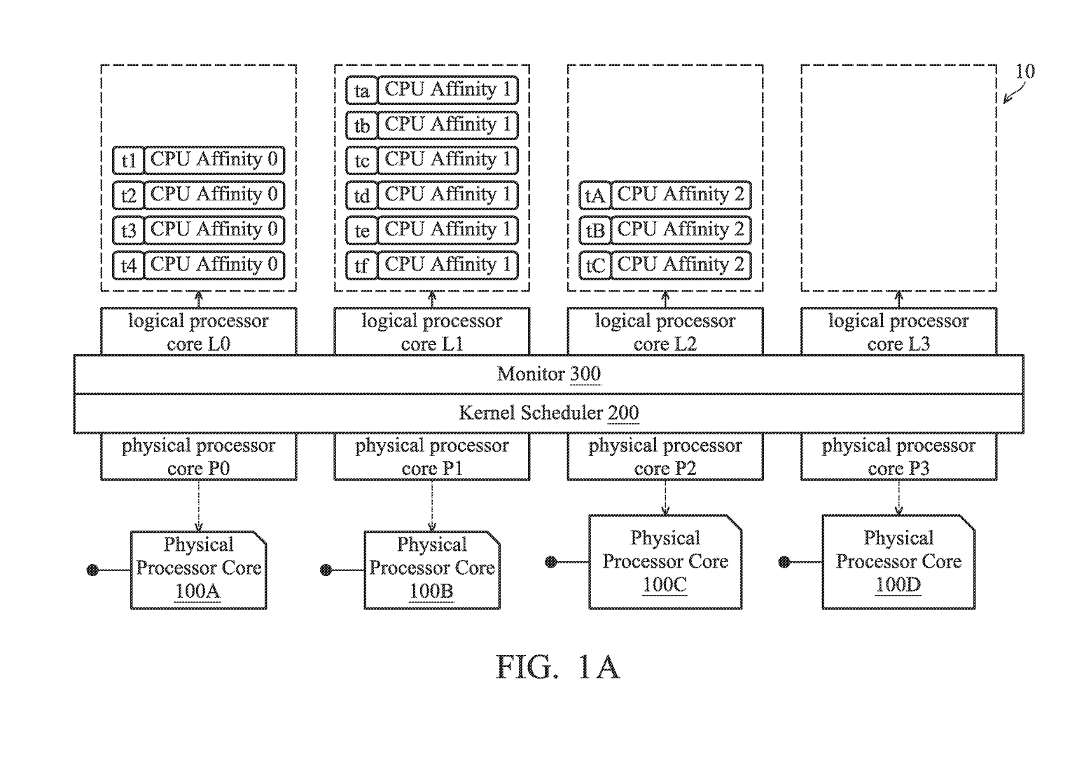

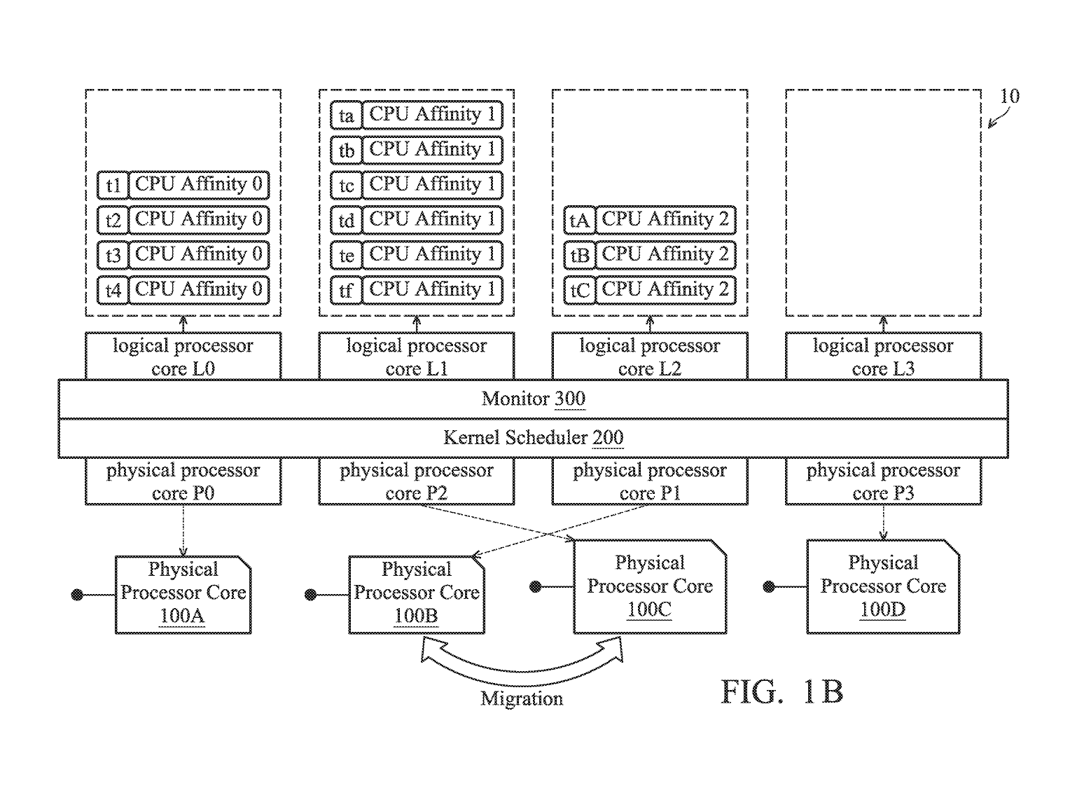

FIG. 1A is a schematic diagram of a multi-core processor system 10 according to an embodiment of the present invention. The multi-core processor system 10 could be a multi-processor architecture of an electronic device. The electronic device could be a mobile electronic device such as a cell phone, a tablet computer, a laptop computer or a PDA, or could it be an electronic device such as a desktop computer or a server. As shown in FIG. 1A, the multi-core processor system 10 includes a plurality of physical processor cores 100A-100D, a kernel scheduler 200 and a monitor 300.

The physical processor cores 100A-100D may be Central Processing Units (CPUs) or Graphics Processing Units (GPUs). Moreover, the physical processor cores 100A-100D may be or further include a digital signal processor (DSP), a microcontroller (MCU) or a plurality of parallel processor cores relating the parallel processing environment to implement the operating system (OS), firmware, driver and/or other applications of the multi-core processor system 10.

Moreover, the physical processor cores 100A-100D can have the same or different sizes/structures. For example, the physical processor cores 100A and 100B have identical structures/sizes, but the physical processor cores 100B and 100C have different structures/sizes. For another example, the physical processor cores 100B and 100C have identical structures, but the physical processor cores 100C and 100D have different structures. As a non-limiting example, the physical processor cores 100A and 100B are little processor cores, and the physical processor cores 100C and 100D are big processor cores which have better performance and consume more energy than those of the little processor cores 100A and 100B.

In addition, the physical processor cores 100A-100D can be mapped to a plurality of corresponding logical processor cores L0-L3, respectively. The kernel scheduler 200 can manage the mapping between the physical processor cores 100A-100D and the logical processor cores L0-L3. In FIG. 1A, to illustrate the mapping relationship managed by the kernel scheduler 200, the physical processor cores 100A-100D are represented by corresponding physical processor cores L0-L1, respectively. In other words, the physical processor cores P0-P3 are illustrated for representing the physical processor cores 100A-100D respectively in the management of the mapping relationship by the kernel scheduler 200. As shown, the physical processor core P0 can be mapped to the logical processor core L0, the physical processor core P1 can be mapped to the logical processor core L1, the physical processor core P2 can be mapped to the logical processor core L2, and the physical processor core P3 can be mapped to the logical processor core L3. In different embodiments, each of the physical processor cores 100A-100D can be mapped to one or more logical processor cores, respectively.

The kernel scheduler 200 can also allocate affinities to tasks, which determines the tasks to be run or executed on which of a plurality of logical processor cores correspondingly. In other words, each task can be allocated to have a respective affinity, which is indicative of a logical processor core responsible for running or execution of the task. And according to the mapping relationship, the task is actually run or executed by a physical processor core mapped to the logical processor core, which is indicated by the affinity of the logical processor core.

In a non-limiting example as shown in FIG. 1A, the tasks t1-t4 are all allocated with affinity 0, which indicates that the logical processor core L0 is assigned to execute or run tasks t1-t4, and that the physical processor core P0/110A mapped to the logical processor core L0 is actually responsible the tasks t1-t4. Similarly, tasks ta-tf are allocated with affinity 1, meaning that the logical processor core L1 is responsible for the tasks ta-tf, and that the physical processor core P1/110b actually run the tasks ta-tf. Analogously, tasks tA-tC are allocated with affinity 2, meaning that the logical processor core L2 is responsible for the tasks tA-tC, and that the physical processor core P2/110C actually run the tasks tA-tC. And no task is assigned to the logical processor core L3 and the physical processor core P3/100D.

The monitor 300 is configured to monitor one or more of loading, computing power performance and/or energy consumption of the physical processor cores 100A-100D. For example, the monitor 300 is dynamic voltage/frequency scaling (DVFS) monitor. Moreover, the monitor 300 can also monitors or detects the respective statuses of the physical processor cores 100A-100D, which can be indicative of whether they can deal with their own current tasks or not.

In the embodiment, whether to arrange context migration between different physical processor cores 100A-100B can be determined according to the monitoring by the monitor 300. In different embodiments, whether to arrange context migration can be determined according to different conditions to meet any design requirements. In an embodiment, the monitor 300 can determine whether to perform context migration between which of the physical processor cores 100A-100B, and the monitor 300 can notify the kernel scheduler 200 to arrange the context migration.

The context migration can involve migration of a processor hardware context, from at least one physical processor core to at least one other physical processor core. The processor hardware context of a CPU may be referred to as CPU hardware context, for example. The processor hardware context may comprise one or more of an execution context, an event signal transceiver glue layer, and a debug context. For example, the processor hardware context may comprise all of an execution context, an event signal transceiver glue layer, and a debug context.

Preferably but not limitedly, a processor context switcher (not shown) can be configured to perform the context migration. Moreover, the processor context switcher can be initiated, instructed or generated by the kernel scheduler 200 to perform the migration. In other words, the kernel scheduler 200 can initiate or instruct or generate the processor context switcher to perform the context migration when the kernel scheduler 200 is notified by the monitor 300. For example, in events where at least one of the physical processor cores 100A-100D cannot deal with its own current tasks, the monitor 300 can notify the kernel scheduler 200 to direct the processor context switcher to migrate the processor hardware context from the at least one physical processor core to other one or more physical processor cores.

During or after the migration, the processor context switcher can further remap the physical processor cores P0-P3 to the logical processor cores L0-L3. FIG. 1B is a schematic diagram illustrating the remapped result in an exemplary case. In the exemplary case, when the monitor 300 monitors that the physical processor core 100B is not capable of handling or executing the tasks ta-tf assigned to the logical processor core L1, it can notify the kernel scheduler 200. Directed by the kernel scheduler 200, the processor context switcher can migrate a processor hardware context from the physical processor core 100B to the physical processor core 100C. In addition, the migration, the processor context switcher can remap the physical processor core P1, which represents the physical processor core 100B, to the logical processor core L2, and remaps the physical processor core P2, which represents the physical processor core 100C, to the logical processor core L1 during or after the migration.

In the embodiment, two physical processor cores are involved in the context migration. In other embodiments, more than two migrations among the physical processor cores can be performed at the same time. In other words, it is allowed for two or more than two physical processor cores to be involved in the migrations at the same time. For example, at the same time when the processor hardware context is migrated from a first physical processor core to a second physical processor core, the processor content switcher not only migrates a processor hardware context from the first physical processor core to the second physical processor core, but also migrates another processor hardware context from a third physical processor core to a fourth physical processor core.

Therefore, the migration of the processor hardware context and the remapping between the logical and physical processor cores could be performed without the awareness of the OS (operating system). From the point of view of the OS, it can be aware that the first logical processor core becomes capable of handling the heavy-loading tasks, but it may not be aware that the first logical processor core has been remapped to the second physical processor core which actually deals with the heavy-loading tasks. Accordingly, the switching method of the embodiments can improve the latency and provide a high performance.

In summary, in the embodiments, processor hardware context can be migrated between different physical processor cores, which can be remapped to different logical processor cores during or after the context migration. This is in contrast to a conventional migration methods which migrate tasks between different logical processor cores fixedly mapped with physical processor cores. It is noted that in different embodiments, either or both of migrating tasks between logical processor cores with fixed mapping relationship between logical and physical processor cores and migrating processor hardware contexts between physical processor cores with non-fixed mapping relationship between logical and physical processor cores can be performed.

More specifically the context migration of the switching method of the embodiments can be simply achieved by migrating the processor hardware context between the physical processor cores and exchanging the mapping relationships of the physical processor cores with their corresponding logical processor cores. Since the switching method of the embodiments migrates the processor hardware context between the physical processor cores 100A-100D, a hot-plug operation may not need to be performed during the migration. Compared with the conventional method which migrates tasks between logical processor cores L0-L3 and therefore needs a hot-plug operation, the switching method of the embodiments can spend less computation and result in higher speed. Furthermore, since the switching method of the embodiments is able to migrate a group of tasks with the same CPU affinity, request for performance burst can be handled properly and precisely, particularly for processor cores with different sizes/structures. This means that the loading of the processor cores could be balanced dynamically and more properly. Consequently, the switching method of the embodiments can simplify a migration process, thus decreasing performance degradation and latency.

It is noted that the processor context switcher could be embedded originally by the OS of the multi-core processor system 10 or generated by the kernel scheduler 200 in required conditions. In addition, the processor context switcher can be implemented separate from or as part of the kernel scheduler 200. Moreover, the processor context switcher 140 could be hardware, software or their combination. In a specific embodiment of implementation as software, the processor context switcher is a task with higher priority than other tasks.

In an exemplary case that the processor context switcher is a task to perform the migration of the processor hardware context between the physical processor cores 100B and 100C. In some embodiments, other tasks of the physical processor cores 100B and 100C will be postponed or stopped temporarily while the migration is executed by the processor context switcher 140. However, other physical processor cores, such as physical processor cores 100A and 100D, can not be affected or changed during the migration performed by the processor context switcher 140. Therefore, the performance of the physical processor cores 100A and 100D may not degrade. In some other embodiments, tasks assigned to the physical processor cores 100B and 100C may not be postponed or stopped temporarily while the migration is executed by the processor context switcher 140.

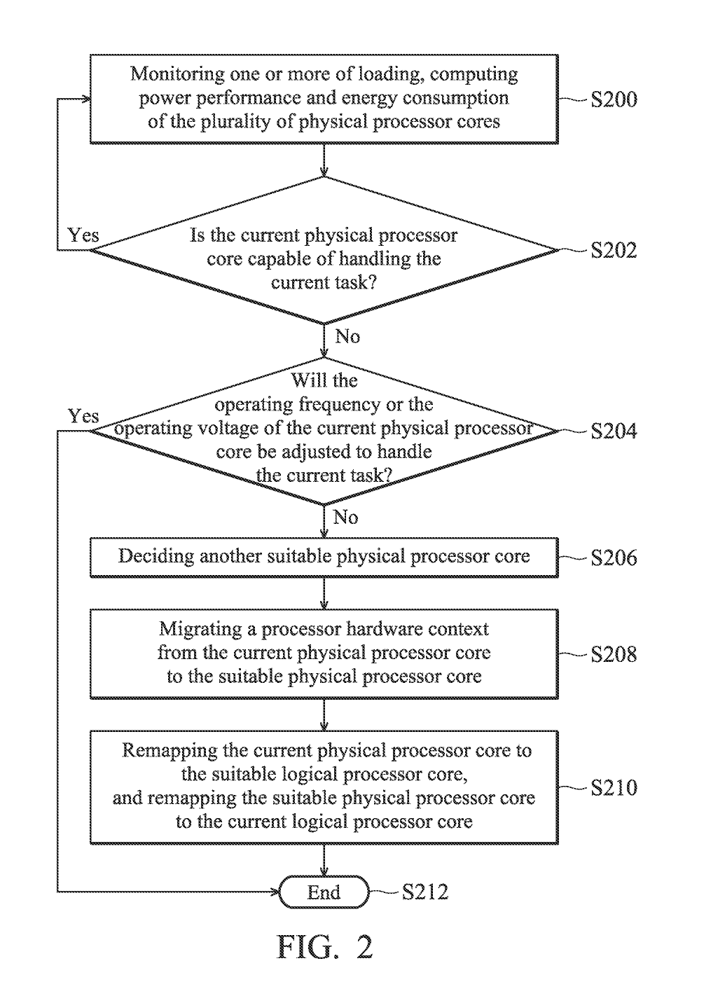

FIG. 2 is a flowchart illustrating the switching method according to an embodiment of the present invention. The switching method in the embodiment can be performed in the multi-core processor system of shown in FIGS. 1A-1B but not limited thereto. In step S200, one or more of loading, computing power performance and energy consumption of the plurality of physical processor cores 100A-100D can be monitored. Afterwards, in step S202, a determination is made about whether or not the current physical processor core is capable of handling or dealing with the current task. When the current physical processor core not capable of handling the current task, the step S200 is executed again. When the current physical processor core is not capable of handling the current task, the step S204 is executed. In step S204, a determination can be made about whether or not an operating frequency or an operating voltage of the current physical processor core is adjusted to handle the current task. When the operating frequency or the operating voltage of the current physical processor core will be adjusted, the process flow can go to step S212. Conversely, when the operating frequency or the operating voltage of the current physical processor core will not be adjusted, step S206 can be executed. In step S206, another suitable physical processor core can be determined. The status of each of the physical processor cores and the suitable one among the physical processor cores can be determined according to the monitored result indicating their performance, loading and/or energy consumption. However, when there is not any suitable physical processor core, the process can go to Step 212. In another embodiment, the step S204 could also be skipped, which means that the step S206 is executed directly when the current physical processor core is not capable of handling the current task as shown in step S202.

In step S208, a processor hardware context can be migrated from the current physical processor core to the suitable physical processor core. It should be noted that in some embodiments, the migration of the processor hardware context can be executed in the bottom layer or the lowest layer of the OS. In step S210, the current physical processor core can be remapped to a suitable logical processor core, which is originally mapped to the suitable physical processor core determined in step S206, and also the suitable physical processor core can be remapped to a current logical processor core, which is originally mapped to the current physical processor core. Afterwards, the process flow can end as shown in step S212. It is noted that steps S200-S206 can be preferably (but not limitedly) performed, at least partially by the monitor 200 and kernel scheduler 200 in FIGS. 1A-1B; Step 208-210 can be preferably (but not limitedly) performed, at least partially, by the processor context switcher that is initiated or directed by the kernel scheduler 200. Details of the operations of the switching method will be further illustrated in the following embodiments.

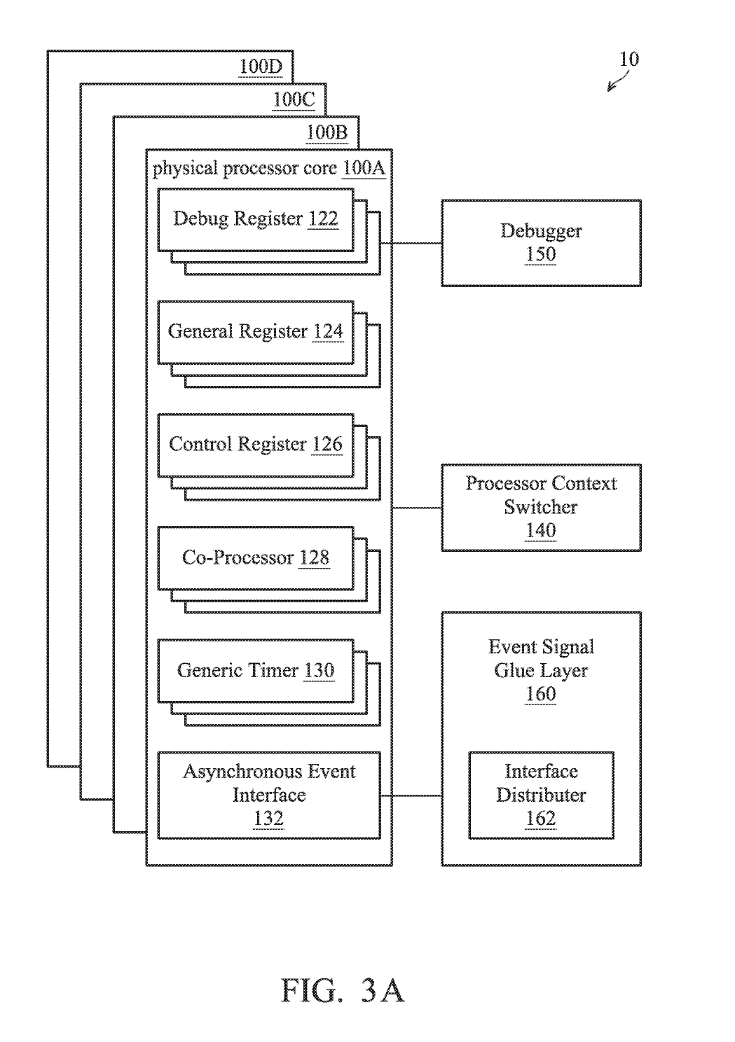

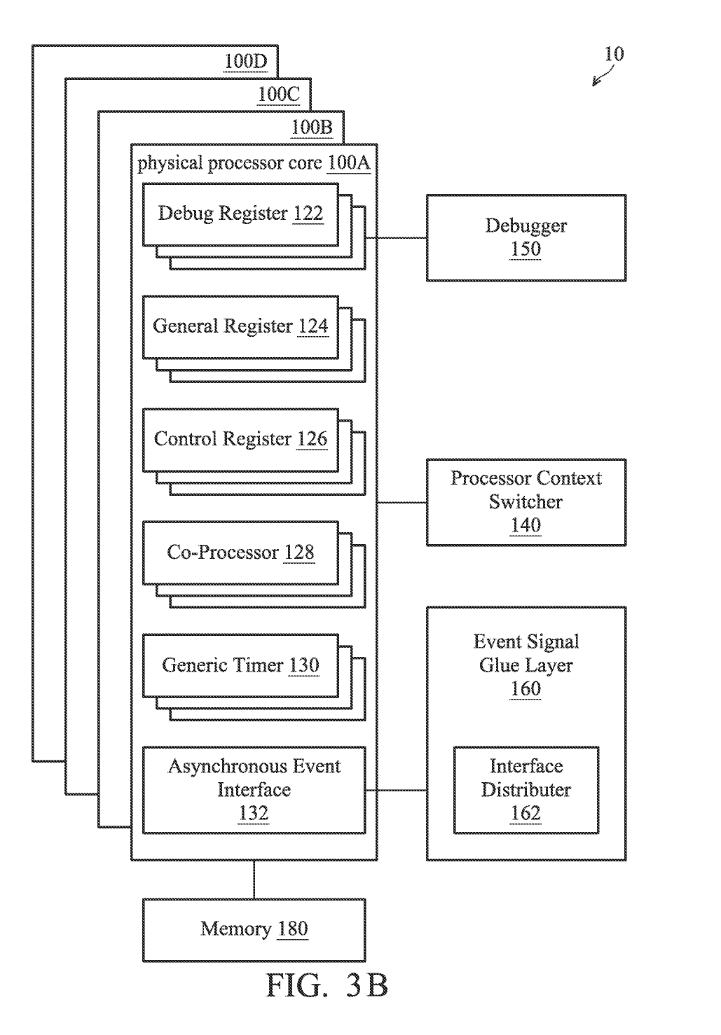

FIG. 3A is a schematic diagram of a multi-core processor system 10 according to an embodiment of the present invention. The multi-core processor system 10 includes a plurality of physical processor cores 100A-100D, a processor context switcher 140, a debugger 150 and an event signal glue layer 160. The debugger 150 and the event signal glue layer 160 can be coupled to the processor cores 100A-100D. In one embodiment, each of the physical processor cores 100A-100D includes one or more debug registers 122, one or more general registers 124, one or more control registers 126, one or more co-processor 128, one or more generic timers 130 and/or an asynchronous event interface 132. In a non-limiting example, the one or more co-processors 128 can be implemented as one or more floating point co-processors.

In one embodiment, the processor hardware context migrated by the processor context switcher 140 includes an execution context, an event signal transceiver glue layer, and/or a debug context. In this embodiment, contents of the one or more general registers 124, the one or more control registers 126, the one or more generic timers 130, and the one or more co-processors 128 of the first physical processor core can be migrated or moved, by the processor context switcher 140, to those of the second physical processor core. It is noted that the processor context switcher 140 may further modify the contents of the one or more control registers 126 of the first physical processor core to be suitable for execution of the second physical processor core prior to the moving the contents of the one or more control registers 126 of the first physical processor core to the one or more control register 126 of the second physical processor core.

Moreover, the one or more respective debug registers 122 may be commonly coupled to a debugger 150 as shown in FIG. 3A. The processor context switcher 140 can further move the contents of the one or more debug registers 122 of the first physical processor core to the one or more debug registers 122 of the second physical processor core, when it executes the migration of the debug context from the first physical processor core to the second physical processor core.

More specifically, as shown in FIG. 3A, the event signal transceiver glue layer 160 includes an interface distributer 162, and the asynchronous event interfaces 132 of the physical processor cores 100A-100C are commonly coupled to the interface distributer 162 of the event signal transceiver glue layer 160. The processor context switcher 140 further reconfigures the interface distributer 162 of the event signal transceiver glue layer 160 when it executes the migration of the event signal transceiver glue layer 160 from the first physical processor core to the second physical processor core.

It should be noted that the event signal transceiver glue layer 160 can also include Interrupt Request (IRQ), Fast Interrupt Request (FIQ) and/or one or more event routes to handle or process the interrupt requests between the physical processor cores. Furthermore, the event signal transceiver glue layer 160 could also be configured to allocate or distribute various kinds of interfaces of the physical processor cores with the Generic Interrupt Controller (GIC).

It is noted that, in the embodiment shown in FIG. 3A, the processor context switcher 140 can directly migrate the processor hardware context from the first physical processor core to the second physical processor core. This means that a memory may not be required to facilitate the migration process. However, the switching method in other embodiment may not be limited thereto. FIG. 3B is another schematic diagram of a multi-core processor system 10 according to such an embodiment of the present invention, in which the processor context switcher 140 can indirectly migrate the processor hardware context from the first physical processor core to the second physical processor core.

As shown in FIG. 3B, a memory 180 can be coupled to the physical processor cores 100A-100D. The memory 180 can include one or a plurality of a random access memory (RAM), a read-only memory (ROM), a flash memory, a register, a hard disk, a soft disk, a magnetic memory, a compact disc (CD) and/or a digital video disk (DVD). The memory 180 can be configured to save contents of the execution context and the debug context of a first physical processor core undergoing migration. Afterwards, the saved contents of the execution context and the debug context of the first physical processor core can be reloaded from the memory 180 to the second physical processor core.

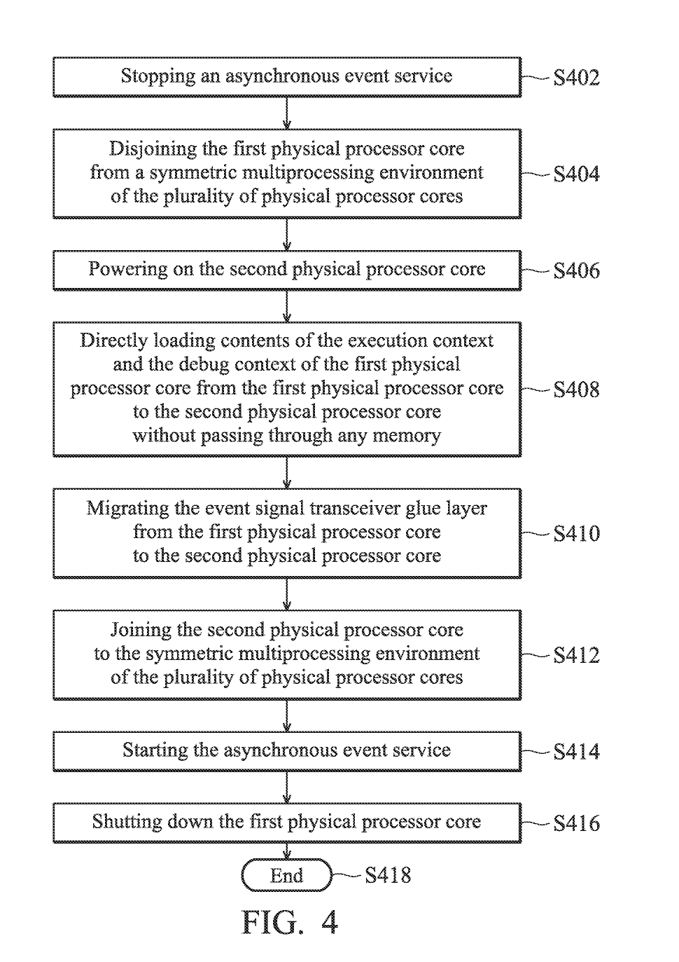

FIG. 4 is a flowchart illustrating the switching method for context migration among a plurality of physical processor cores according to an embodiment of the present invention. The switching method can be performed by the processor context switcher 140 in FIG. 3A but not limited thereto. In step S402, an asynchronous event service can be stopped. In step S404, the first physical processor core can be disjoined or disconnected from a symmetric multiprocessing environment of the plurality of physical processor cores. Afterwards, in step S406, which is an optional step, the second physical processor core can be powered on in cases where it is originally powered down. In step S408, contents of the execution context and the debug context of the first physical processor core can be loaded from the first physical processor core to the second physical processor core without passing through any memory. In step S410, the event signal transceiver glue layer can be migrated or moved from the first physical processor core to the second physical processor core. Afterwards, the second physical processor core is joined to the symmetric multiprocessing environment of the plurality of physical processor cores as shown in step S412. In step S414, the asynchronous event service can be started or initiated by the processor context switcher 140. Furthermore, as shown in step S416, which is an optional step, the first physical processor core may be shut down or disconnected. For example, in cases where the second physical processor core is originally powered down, the first physical processor core may be shut down or disconnected. And the process flow can end in step S418.

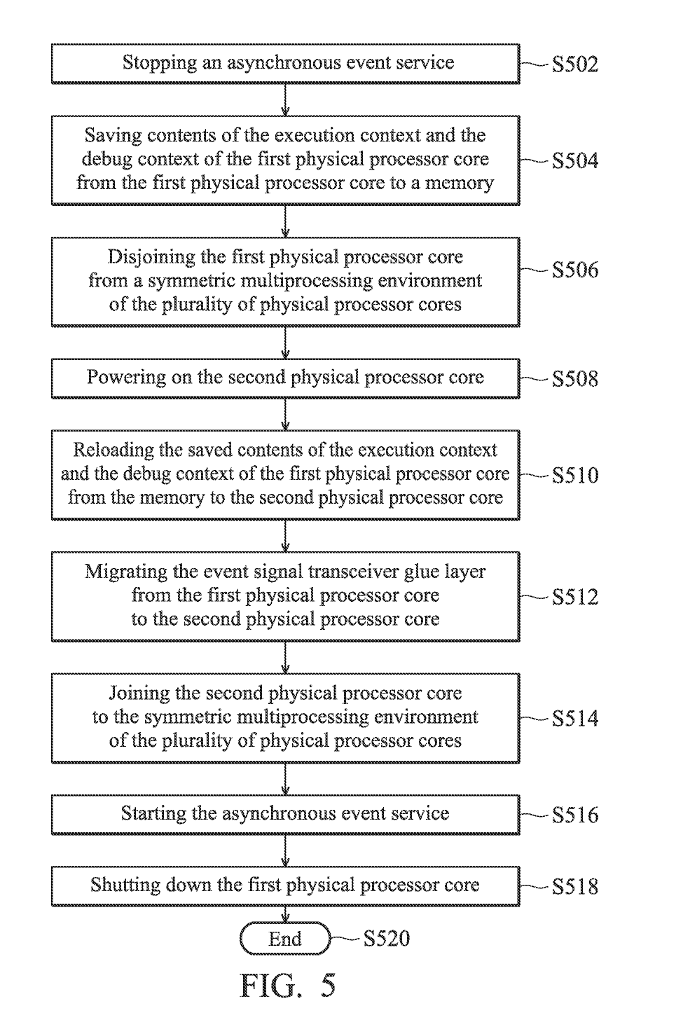

FIG. 5 is a flowchart illustrating the switching method for context migration among a plurality of physical processor cores according to another embodiment of the present invention. The switching method can be performed by the processor context switcher 140 in FIG. 3B but not limited thereto. The main difference between FIG. 5 and FIG. 4 is that after asynchronous event service is stopped or terminated in step S502, in a step S504 is added, where contents of the execution context and the debug context of the first physical processor core from the first physical processor core can be saved to a memory. Similar to FIG. 4 the first physical processor core can be disjoined from a symmetric multiprocessing environment of the plurality of physical processor cores in step S506, and the second physical processor core can be powered on in step S508 (optional) in cases where it is originally powered down. In step S510 which is slightly from step S408 of FIG. 4, the saved contents of the execution context and the debug context of the first physical processor core can be reloaded from the memory to the second physical processor core. The following steps S512-S518 are similar to Steps S410-S416 and details are omitted here for brevity.

The switching method and the multi-core processor system according to the embodiments can bring many advantages to hardware and software. The migration in the embodiment can be referred to as processor/CPU hardware context migration, which can migrate a group of tasks with the same affinity during each migration. Computation and time can be therefore enormously saved in comparison to the conventional method utilizing task context migration in the operating system.

Specifically, time of migrating context can be enormously saved. In a non-limiting example, context migration between processor cores in a big.LITTLE according to the switching method of one embodiment can take only 1/10 of the migration time required in a conventional method that migrate tasks between logical processor cores fixedly mapped with physical processor cores and thus requires a lengthy hot-plug flow.

In addition, with respect to SW, it may only need to remap physical processor cores to logical processor cores. The processor context switcher may migrate the processor hardware context between the two physical processor cores without informing the OS of the multi-core processor system. Namely, the OS may be unaware of the migration of the processor hardware context. Moreover, there may be no overhead of migration at a task level. Furthermore, algorithms for balancing load can be simplified and performed more quickly, particularly in different sizes of processor cores.

In summary, the switching method and the multi-core processor system according to the embodiments can provide a faster migration process, thus capable of addressing requests for performance burst more precisely and quickly. In addition, the switching method and the multi-core processor system according to the embodiments can have shorter latency, while simplifying the performance/load balance scheduling algorithms.

Although embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A switching method for context migration among a plurality of physical processor cores, wherein each of the physical processor cores is mapped to a corresponding logical processor core, the method comprising:
migrating a processor hardware context from a first physical processor core to a second physical processor core which is different from the first physical processor core, wherein the first physical processor core and the second physical processor core are mapped to a first logical processor core and a second logical processor core which is different from the first logical processor core, respectively prior to the migration; and
remapping the first physical processor core to the second logical processor core, and remapping the second physical processor core to the first logical processor core.

2. The switching method as claimed in claim 1, wherein the processor hardware context comprises an execution context, an event signal transceiver glue layer, and a debug context.

3. The switching method as claimed in claim 2, wherein each of the physical processor cores comprises respective one or more general registers, respective one or more control registers, respective one or more generic timers, and respective one or more floating point co-processor cores, and the step of migrating the execution context from the first physical processor core to the second physical processor core comprises further comprises moving contents of the one or more general registers, the one or more control registers, the one or more generic timers, and the one or more floating point co-processor cores of the first physical processor core to those of the second physical processor core.

4. The switching method as claimed in claim 3, further comprising modifying the contents of the one or more control registers of the first physical processor core to be suitable for execution of the second physical processor core prior to moving the contents of the one or more control registers of the first physical processor core to the one or more control registers of the second physical processor core.

5. The switching method as claimed in claim 2, wherein the event signal transceiver glue layer comprises an interface distributer, and each of the physical processor cores has a respective asynchronous event interface commonly coupled to the interface distributer of the event signal transceiver glue layer, and the step of migrating the event signal transceiver glue layer from the first physical processor core to a second physical processor core further comprises reconfiguring the interface distributer of the event signal transceiver glue layer.

6. The switching method as claimed in claim 2, wherein each of the physical processor cores has one or more respective debug registers commonly coupled to a debugger, and the step of migrating the debug context from the first physical processor core to the second physical processor core further comprises moving the contents of the one or more debug registers of the first physical processor core to the one or more debug registers of the second physical processor core.

7. The switching method as claimed in claim 1, wherein the step of migrating the processor hardware context from the first physical processor core to the second physical processor core is performed directly or indirectly from the first physical processor core to the second physical processor core.

8. The switching method as claimed in claim 2, wherein the step of migrating the processor hardware context from the first physical processor core to the second physical processor core further comprises:
saving contents of the execution context and the debug context of the first physical processor core from the first physical processor core to a memory; and
reloading the saved contents of the execution context and the debug context of the first physical processor core from the memory to the second physical processor core.

9. The switching method as claimed in claim 8, wherein the step of migrating the processor hardware context from the first physical processor core to the second physical processor core further comprises:
disjoining the first physical processor core from a symmetric multiprocessing environment of the plurality of physical processor cores between the step of saving contents of the execution context and the debug context of the first physical processor core and the step of reloading the saved contents of the execution context and the debug context of the first physical processor core; and
joining the second physical processor core to the symmetric multiprocessing environment of the plurality of physical processor cores after the step of reloading the saved contents of the execution context and the debug context of the first physical processor core.

10. The switching method as claimed in claim 9, further comprising:
stopping an asynchronous event service before the step of saving contents of the execution context and the debug context of the first physical processor core;
migrating the event signal transceiver glue layer from the first physical processor core to the second physical processor core between the step of reloading the saved contents of the execution context and the debug context of the first physical processor core and the step of joining the second physical processor core to the symmetric multiprocessing environment; and
starting the asynchronous event service after the step of joining the second physical processor core to the symmetric multiprocessing environment.

11. The switching method as claimed in claim 8, wherein the step of migrating the processor hardware context from the first physical processor core to the second physical processor core further comprises powering on the second physical processor core before the step of reloading the saved contents of the execution context and the debug context of the first physical processor core.

12. The switching method as claimed in claim 2, wherein the step of migrating the processor hardware context from the first physical processor core to the second physical processor core further comprises directly loading contents of the execution context and the debug context of the first physical processor core from the first physical processor core to the second physical processor core without passing through any memory.

13. The switching method as claimed in claim 12, wherein the step of migrating the processor hardware context from the first physical processor core to the second physical processor core further comprises:
disjoining the first physical processor core from a symmetric multiprocessing environment of the plurality of physical processor cores before the step of loading contents of the execution context and the debug context of the first physical processor core; and
joining the second physical processor core to the symmetric multiprocessing environment of the plurality of physical processor cores after the step of loading contents of the execution context and the debug context of the first physical processor core.

14. The switching method as claimed in claim 13, further comprising:
stopping an asynchronous event service before the step of loading contents of the execution context and the debug context of the first physical processor core;
migrating the event signal transceiver glue layer from the first physical processor core to the second physical processor core between the step of loading the execution context and the debug context of the first physical processor core and the step of joining the second physical processor core to the symmetric multiprocessing environment; and
starting the asynchronous event service after the step of joining the second physical processor core to the symmetric multiprocessing environment.

15. The switching method as claimed in claim 12, wherein the step of migrating the processor hardware context from the first physical processor core to the second physical processor core further comprises powering on the second physical processor core before the step of loading contents of the execution context and the debug context of the first physical processor core.

16. The switching method as claimed in claim 1, further comprising:
detecting one or more of loading, computing power performance and energy consumption of the plurality of physical processor cores; and
performing the migration according to the detection.

17. The switching method as claimed in claim 1, wherein the physical processor cores are Central Processing Units or Graphics Processing Units.

18. The switching method as claimed in claim 1, further comprising migrating physical processor core at the same time when the processor hardware context is migrated from the first physical processor core to the second physical processor core.

19. The switching method as claimed in claim 1, wherein the first and second physical processor cores have identical or different structures and/or sizes.

20. A multi-core processor system, comprising:
a plurality of physical processor cores, wherein each of the physical processor cores is mapped to a corresponding logical processor core of a plurality of logical processor cores, the physical processor cores comprising a first physical processor core and a second physical processor core which is different from the first physical processor core, and the logical processor cores comprise a first logical processor core and a second logical processor core which is different from the first logical processor core; and
a processor context switcher, configured to migrate a processor hardware context from the first physical processor core to the second physical processor core, wherein the first physical processor core and the second physical processor core are mapped to the first logical processor core and the second logical processor core respectively prior to the migration, and the processor context switcher further remaps the first physical processor core to the second logical processor core and remaps the second physical processor core to the first logical processor core.

21. The multi-core processor system as claimed in claim 20, wherein the processor hardware context comprises an execution context, an event signal transceiver glue layer, and a debug context.

22. The multi-core processor system as claimed in claim 21, wherein each of the physical processor cores comprises respective one or more general registers, respective one or more control registers, respective one or more generic timers, and respective one or more floating point co-processor cores, and the processor context switcher moves contents of the one or more general registers, the one or more control registers, the one or more generic timers, and the one or more floating point co-processor cores of the first physical processor core to those of the second physical processor core.

23. The multi-core processor system as claimed in claim 22, wherein the processor context switcher further modifies the contents of the one or more control registers of the first physical processor core to be suitable for execution of the second physical processor core prior to moving the contents of the one or more control registers of the first physical processor core to the one or more control registers of the second physical processor core.

24. The multi-core processor system as claimed in claim 21, wherein the event signal transceiver glue layer comprises an interface distributer, and each of the physical processor cores has a respective asynchronous event interface commonly coupled to the interface distributer of the event signal transceiver glue layer, and the processor context switcher further reconfigures the interface distributer of the event signal transceiver glue layer when it executes the migration of the event signal transceiver glue layer from the first physical processor core to a second physical processor core.

25. The multi-core processor system as claimed in claim 21, wherein each of the physical processor cores has one or more respective debug registers commonly coupled to a debugger, and the processor context switcher further moves the contents of the one or more debug registers of the first physical processor core to the one or more debug registers of the second physical processor core when it executes the migration of the debug context from the first physical processor core to the second physical processor core.

26. The multi-core processor system as claimed in claim 20, wherein the processor context switcher migrates the processor hardware context from the first physical processor core to the second physical processor core directly or indirectly.

27. The multi-core processor system as claimed in claim 21, wherein when the processor context switcher executes the migration of the processor hardware context from the first physical processor core to the second physical processor core, it further:
saves contents of the execution context and the debug context of the first physical processor core from the first physical processor core to a memory; and
reloads the saved contents of the execution context and the debug context of the first physical processor core from the memory to the second physical processor core.

28. The multi-core processor system as claimed in claim 27, wherein when the processor context switcher executes the migration of the processor hardware context from the first physical processor core to the second physical processor core, it further:
disjoins the first physical processor core from a symmetric multiprocessing environment of the plurality of physical processor cores between the execution of saving contents of the execution context and the debug context of the first physical processor core and the execution of reloading the saved contents of the execution context and the debug context of the first physical processor core; and
joins the second physical processor core to the symmetric multiprocessing environment of the plurality of physical processor cores after the execution of reloading the saved contents of the execution context and the debug context of the first physical processor core.

29. The multi-core processor system as claimed in claim 28, wherein the processor context switcher further:
stops an asynchronous event service before the execution of saving contents of the execution context and the debug context of the first physical processor core;
migrates the event signal transceiver glue layer from the first physical processor core to the second physical processor core between the execution of reloading the saved contents of the execution context and the debug context of the first physical processor core and the execution of joining the second physical processor core to the symmetric multiprocessing environment; and
starts the asynchronous event service after the execution of joining the second physical processor core to the symmetric multiprocessing environment.

30. The multi-core processor system as claimed in claim 27, wherein when the processor context switcher migrates the processor hardware context from the first physical processor core to the second physical processor core, the processor context switcher further powers on the second physical processor core before it reloads the saved contents of the execution context and the debug context of the first physical processor core.

31. The multi-core processor system as claimed in claim 21, wherein when the processor context switcher migrates the processor hardware context from the first physical processor core to the second physical processor core, the processor context switcher directly loads contents of the execution context and the debug context of the first physical processor core from the first physical processor core to the second physical processor core without passing through any memory.

32. The multi-core processor system as claimed in claim 31, wherein when the processor context switcher executes the migration of the processor hardware context from the first physical processor core to the second physical processor core, it further:
disjoins the first physical processor core from a symmetric multiprocessing environment of the plurality of physical processor cores before the execution of loading contents of the execution context and the debug context of the first physical processor core; and
joins the second physical processor core to the symmetric multiprocessing environment of the plurality of physical processor cores after the execution of loading contents of the execution context and the debug context of the first physical processor core.

33. The multi-core processor system as claimed in claim 32, wherein the processor context switcher:
stops an asynchronous event service before the step of loading contents of the execution context and the debug context of the first physical processor core;
migrates the event signal transceiver glue layer from the first physical processor core to the second physical processor core between the execution of loading the execution context and the debug context of the first physical processor core and the execution of joining the second physical processor core to the symmetric multiprocessing environment; and
starts the asynchronous event service after the execution of joining the second physical processor core to the symmetric multiprocessing environment.

34. The multi-core processor system as claimed in claim 31, when the processor context switcher migrates the processor hardware context from the first physical processor core to the second physical processor core, the processor context switcher further powers on the second physical processor core before the execution of loading contents of the execution context and the debug context of the first physical processor core.

35. The multi-core processor system as claimed in claim 20, wherein the multi-core processor system further comprises a monitor configured to monitoring one or more of loading, computing power performance and energy consumption of the plurality of physical processor cores, and the processor context switcher performs the migration according to the monitoring.

36. The multi-core processor system as claimed in claim 20, wherein the physical processor cores are Central Processing Units or Graphics Processing Units.

37. The multi-core processor system as claimed in claim 20, further comprising:
a third physical processor core; and
a fourth physical processor core which is different from the third physical processor core, wherein the processor context switcher migrates another processor hardware context from the third physical processor core to the fourth physical processor core at the same time when the processor hardware context is migrated from the first physical processor core to the second physical processor core.

38. The multi-core processor system as claimed in claim 20, wherein the first and second physical processor cores have identical or different structures and/or sizes.
